(19) United States
(12) Patent Application Publication
(10) Pub. No.: US 2015/0241022 A1
(43) Pub. Date: Aug. 27, 2015

(54) LAMP STRUCTURE FOR IMPROVEMENT OF LUMINOUS EFFICIENCY

(71) Applicant: KUO-CHIN HUANG, TAINAN (TW)

(72) Inventor: KUO-CHIN HUANG, TAINAN (TW)

(21) Appl. No.: 14/186,256

(22) Filed: Feb. 21, 2014

(51) Int. Cl. F21V 5/04; F21V 5/00

(52) U.S. Cl. CPC F21V 5/045; F21V 5/04; F21V 5/008

(57) ABSTRACT

The invention relates to a lamp structure for improvement of a luminous efficiency. A effective light incident angle of a primary lens is equal to or larger than a light emergent angle of a light source, and the light emergent angle of the primary lens is equal to or smaller than an effective light incident angle of a terminal lens, so that the effect of enhancing light brightness and a light shape projected from the terminal lens is achieved.

### BACKGROUND OF THE INVENTION

1. Fields of the Invention

The present invention relates to a lamp structure for improvement of a luminous efficiency by enhancing the brightness and light shape of projected light as required.

2. Descriptions of Related Art

A light emitting diode (LED) or a surface-mount device light emitting diode (SMD LED) generally has a certain range of emergence angle of light. If an emergence angle of light as requested by users does not fall into a predetermined range of values, users must entrust a manufacturer to additionally have items custom-made according to their demands. Also, in consideration of cost-effective factors, manufacturers often raise prices for sales and require a minimum order quantity of products, which relatively result in a higher purchasing costs for users and even users' ordered quantity is often far less than the minimum order quantity as requested by the manufacturers. This is the main reason why a lack of orders or delayed orders from users often occurs.

In addition, conventional electronic products using LEDs available on the market all have to further use a reflective element to reflect and then project weak scattered light at the perimeter of LEDs. However, after reflecting from the reflective element, the weak scattered light will be subject to a decay of brightness, so the overall brightness enhancement of the LEDs is quite limited.

As further discussing about lightings or lamps used in motorcycles or cars available on the market, they are mainly designed with stronger lighting functions, a longer life span, an energy saving efficiency, a smaller volume, shapes or styles in a more convenient manner, and so on.

As referring to a conventional vehicle lamp structure, disclosed in a Taiwan patent registration number I294370, issued on 11 Mar. 2008, it comprises a light emitting element, a shutter, a lens and an ellipsoidal reflector, wherein the light emitting element is a halogen lamp disposed in the ellipsoidal reflector, the lens disposed on an optical path after the shutter and the shutter located on a focus of an optical axis of the ellipsoidal reflector. When the light emitting element starts, its light is scatteringly emitted in all directions, and the scattered light is further reflected to the focus of the ellipsoidal reflector after the light shines on the ellipsoidal reflector. Some light reflected to the focus is sheltered from the shutter; in other words, only a part of light passes the shutter and is projected through the lens for shaping so as to comply with regulations or rules relevant to specific cross-sectional shapes of vehicle lamps.

However, since the energy loss of the light projected from the light emitting element of the car lighting is caused by the reflection of the ellipsoidal reflector and some light is sheltered from the shutter for shaping so the light utilization of the car lighting is not good. Thus, the conventional vehicle lamp structure as aforesaid is designed to provide a light beam along a light emitting direction, and the vertical section of the light beam is a predetermined shape. In such a case, the vehicle lamp discloses the light emitting element having a light emitting surface in a surface-like shape and the lens disposed on the path of the light emitted from the surface-shaped light emitting element. Meanwhile, the shape of the light emitting surface is corresponding to the shape of the above predetermined shape. Therefore, the sectional shape of the light beam provided by the surface-shaped light emitting element is the shape of the light emitting surface, i.e. the above-mentioned predetermined shape. Thus, after the light emitted from the surface-shaped light emitting element passes through the lens and then projects outwards, the section of the light beam does not need to be shaped by other optical elements. Therefore, it can reduce a brightness decay in the process of shaping.

However, since the surface-shaped light emitting element of the lighting is composed of multiple points of light sources (such as LED chips) arranged in a predetermined shape and all packaged, or it is composed of a single LED chip having a light emitting surface in the predetermined shape. Therefore, there are still disadvantages to be improved in actual manufacturing, that is:
1. When the surface-shaped light emitting element of the lighting is composed of multiple points of light sources arranged in the predetermined shape and packaged, it needs to use lots of light sources. When the projected light shape is changed, and even changing the arranged shape of the points of light sources will also relatively change package ranges, which cannot be applied in mass production.
2. When the surface-shaped light emitting element of the lighting is composed of a single LED chip having a light emitting surface in the predetermined shape, there will be much trouble and difficult in manufacture of the same and possible inaccurate precision will be incurred due to a substantially small size of a LED chip, where a part of the light emitting surface needs to be sheltered from a shutter and packaged. In addition, such a light emitting element of the lighting with single LED chip must be custom-made, so the manufacturing cost will get increased.

### SUMMARY OF THE INVENTION

Therefore, a lamp structure for improvement of luminous efficiency is developed herein. A primary objective of the present invention is to completely collect all light scattered from a light source and transfer the projected angles of all the collected light into an effective light incident angle of a terminal lens for achieving the effect of enhancing light brightness. Meanwhile, the projected light shape may correspond to that in the course of driving with a multi-surface design on the light emergent surface of the terminal lens.

In order to achieve the above objectives, the technological means of a lamp structure for improvement of luminous efficiency in the present invention is revealed herein. A lamp structure for improvement of a luminous efficiency makes an effective light incident angle of a primary lens equal to or larger than a light emergent angle of a light source, so that a light emergent angle projected from the primary lens is equal to or smaller than an effective light incident angle of a terminal lens.

An X-axis ridgeline and a Y-axis ridgeline are intercrossed and formed on a light emergent surface of the terminal lens for dividing the light emergent surface into first, second, third and fourth surface areas. The ridgeline refers to a line formed by the intersection of two adjacent surface areas on which plural highest points are formed. Two adjacent surface areas have corresponding overlapped points with the same curvature relative to any arbitrary highest point of the ridgeline. Under a condition that a first surface region defined by the first and fourth surface areas has a X-axis curvature same with that of a second surface region defined by the second and third surface areas, and a third surface region defined by the first and second surface areas has a Y-axis curvature same with that of a fourth surface region defined by the third and fourth surface areas, the X-axis curvature is not equal to the Y-axis curvature.

Therefore, by the effective light incident angle of the primary lens equal to or larger than a light emergent angle of the light source, and the emergent angle of light projected from the primary lens equal to or smaller than an effective light incident angle of the terminal lens, all light scattered from the light source is completely collected through the primary lens and transferred the light into the effective light incident angle of the terminal lens, so that the object of enhancing the light brightness projected from the terminal lens can be achieved. Further, the terminal lens enables to provide a light shape suitably used in driving as its light emergent surface of the terminal lens is used on the condition of the first and second surface regions having the same X-axis curvature and the third and fourth surface regions having the same Y-axis curvature, wherein the X-axis and Y-axis curvatures differs from each other.

### BRIEF DESCRIPTION OF THE DRAWINGS

The structure and the technical means adopted by the present invention to achieve the above and other objects can be best understood by refereeing to the following detailed description of the preferred embodiments and the accompanying drawings, wherein

FIG. 1 is a diagram showing a first embodiment of a lamp structure for improvement of a luminous efficiency according to the present invention;

FIG. 2 is a diagram showing a second embodiment of a lamp structure for improvement of a luminous efficiency according to the present invention;

FIG. 3 is a perspective view showing the structure of the terminal lens of a lamp structure for improvement of a luminous efficiency according to the present invention;

FIG. 4 is a diagram showing the structure of the light emergent surface of the terminal lens according to the present invention;

FIG. 5 is a diagram showing the sectional shape A1 of the light beam formed by the light source passing the terminal lens of a lamp structure for improvement of a luminous efficiency according to the present invention;

FIG. 6 is a diagram showing the sectional shape A2 of the light beam formed by the light source passing the terminal lens of a lamp structure for improvement of a luminous efficiency according to the present invention;

FIG. 7 is a diagram showing the sectional shape A3 of the light beam formed by the light source passing the terminal lens of a lamp structure for improvement of a luminous efficiency according to the present invention;

FIG. 8 is diagram showing the light-shaped lens disposed on a light emergent side of the terminal lens according to the present invention;

FIG. 9 is a diagram showing the intermediate lens further disposed between the primary lens and the terminal lens of a lamp structure for improvement of a luminous efficiency according to the present invention.

### DETAILED DESCRIPTION OF THE PREFERRED EMBODIMENT

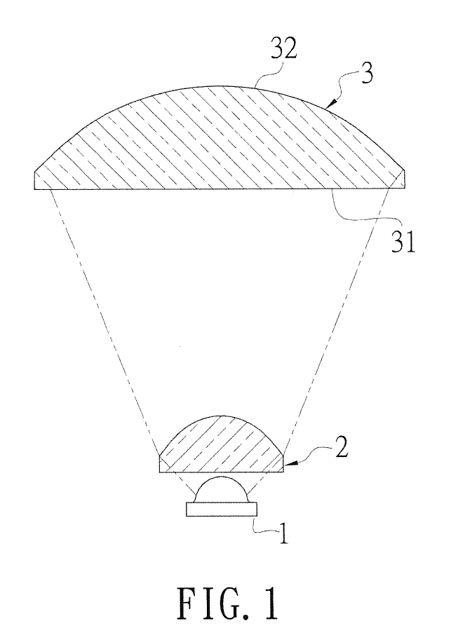

As referring to FIG. 1, it shows a diagram showing a first embodiment of a lamp structure for improvement of a luminous efficiency according to the present invention. The present invention uses a light emitting diode (LED) as a light source (1), and a primary lens (2) is disposed in a light emergent side of the light source (1). A terminal lens (3) is disposed in the light emergent side of the primary lens (2). The primary lens (2) has an effective light incident angle equal to or larger than a light emergent angle of the light source (1), so that a light emergent angle from the primary lens (2) is equal to or smaller than an effective light incident angle of the terminal lens (3).

Thus, all light scattered from the light source (1) is completely collected through the primary lens (2) and transferred to have the effective light incident angle of the terminal lens (3) for enhancing the brightness of the light projected from the terminal lens (3).

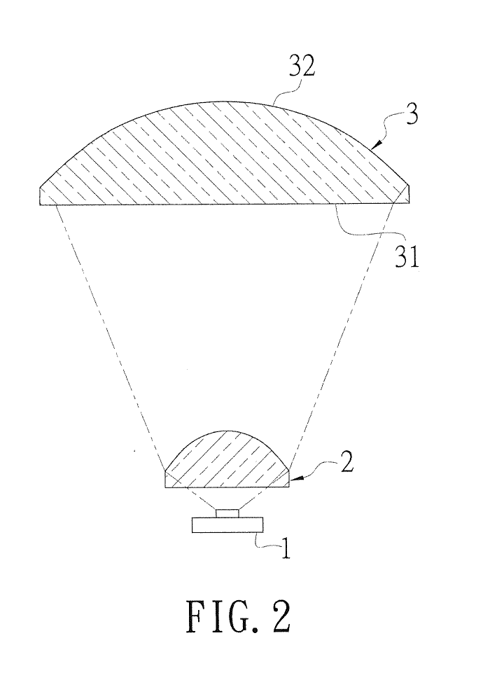

As referring to FIG. 2, it shows a diagram showing a second embodiment of a lamp structure for improvement of a luminous efficiency according to the present invention. The difference between the second embodiment and the first embodiment is a surface-mount device light emitting diode (SMD LED) used as the light source (1) in the second embodiment. Since the effective light incident angle of the primary lens (2) is equal to or larger than the light emergent angle of the light source (1), the light projected from the light source (1) with a larger light emergent angle still completely travels into the primary lens (2) and is further transferred to have the effective light incident angle of the terminal lens (3) through the primary lens (2). Thus, it can achieve the object of enhancing the brightness of the light projected from the terminal lens (3).

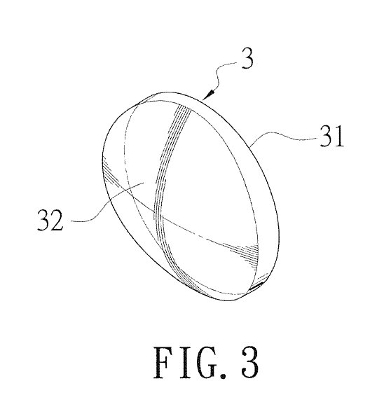

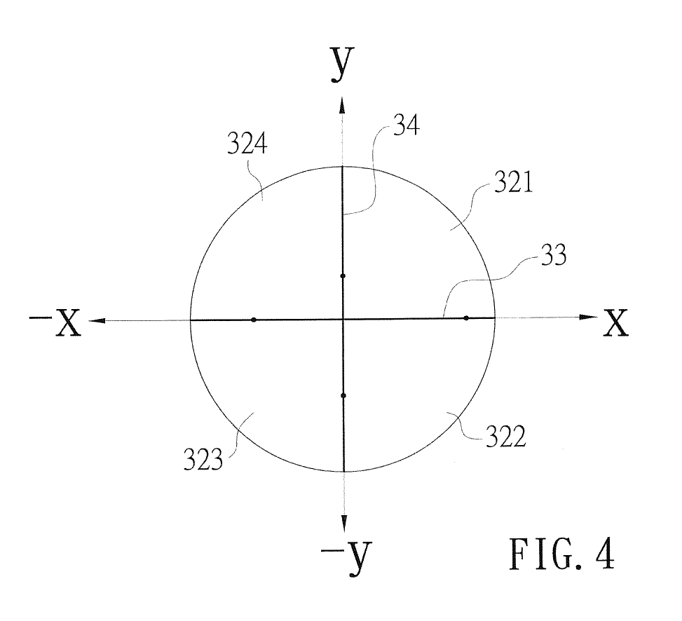

As referring to FIG. 3, the terminal lens (3) comprises a light incident surface (31) and a light emergent surface (32). The light incident surface (31) is a surface that light enters into the terminal lens (3), and the light emergent surface (32) is a surface that light goes out of the terminal lens (3). As referring to FIG. 4, an X-axis ridgeline (33) and a Y-axis ridgeline (34) are intercrossed and formed on the light emergent surface (32) of the terminal lens (3), and then the light emergent surface (32) is clockwise divided into first, second, third and fourth surface areas (321, 322, 323, 324), wherein the “ridgeline” means that a line formed by the intersection of two adjacent surface areas on which plural highest points are formed. Two adjacent surface areas have corresponding overlapped points with the same curvature relative to any arbitrary highest point of the ridgeline. Under a condition that a first surface region defined by the first and fourth surface areas (321, 324) has a X-axis curvature same with that of a second surface region defined by the second and third surface areas (322, 323), and a third surface region defined by the first and second surface areas (321, 322) has a Y-axis curvature same with that of a fourth surface region defined by the third and fourth surface areas (323, 324), the X-axis curvature is not equal to the Y-axis curvature and the light emergent surface (32) is a smooth light emergent curved surface. Accordingly, the shape of light projected from the terminal lens (3) can be adjusted depending on the various curvatures the light emergent surface (32) of the terminal lens (3).

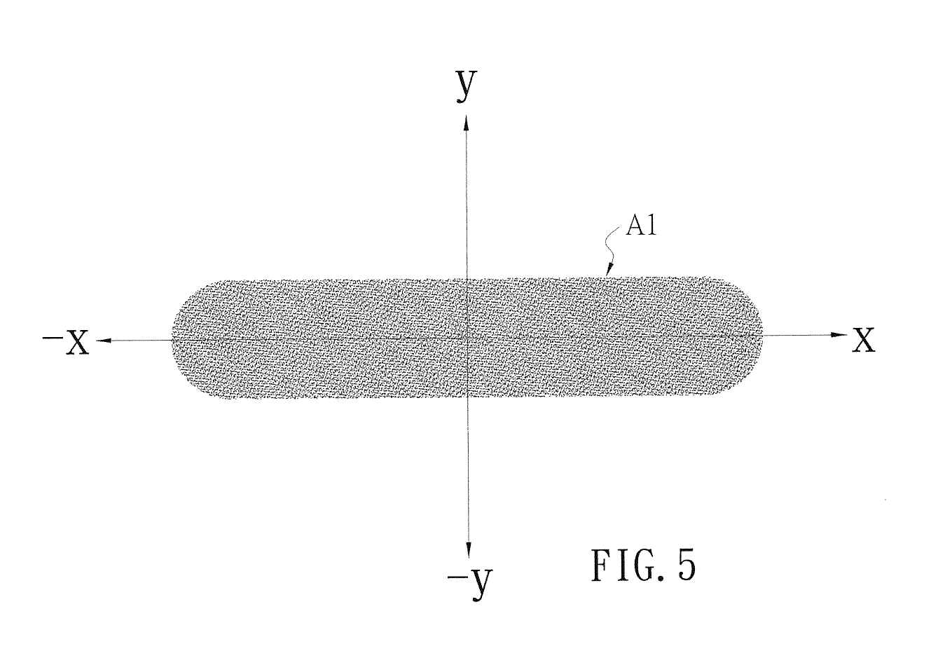

As referring to FIG. 5, it shows a sectional shape A1 of the light beam formed by the light source passing through the terminal lens (3). The length of the sectional shape (A1) along the horizontal direction of X-axis, −X-axis shows a symmetrical state, and the width of the sectional shape (A1) along the vertical direction of Y-axis, −Y-axis also shows a symmetrical state, Further speaking, when it makes an any section on the terminal lens (3) along the Y-axis and −Y-axis directions and parallel to the X-axis and −X-axis, the X-axis curvature of the first and second area curved surface (321) (322) of the section is symmetric to that of the fourth and third surface areas (324) (323) of the section, and when it makes any sections on the terminal lens (3) along the X-axis and −X-axis directions and parallel to the Y-axis and −Y-axis, the Y-axis curvature of the first and second surface areas (321) (322) is symmetric to that of the fourth and third surface areas (324) (323) of the section.

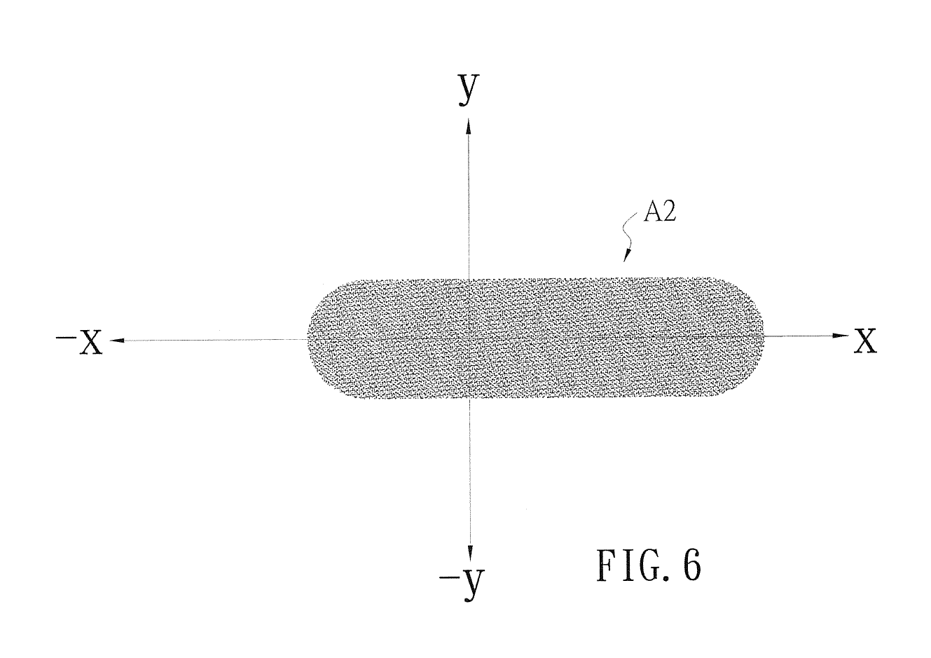

As referring to FIG. 6, it shows a sectional shape A2 of the light beam is formed by the light source passing through the terminal lens (3). The length of the sectional shape (A2) along the X-axis and −X-axis directions shows an asymmetrical state, and the width of the sectional shape (A2) along the Y-axis and −Y-axis directions shows a symmetrical state. Further speaking, when it makes any sections on the terminal lens (3) along the Y-axis and −Y-axis directions and parallel to the X-axis and −X-axis directions, the X-axis curvature of the first and second surface areas (321) (322) is asymmetric to one of the fourth and third surface areas (324) (323) of the section, and when it makes any sections on the terminal lens (3) along the X-axis and −X-axis directions and parallel to the Y-axis and −Y-axis directions, the Y-axis curvature of the first and second surface areas (321) (322) is symmetric to that of the fourth and third surface areas (324) (323) of the section.

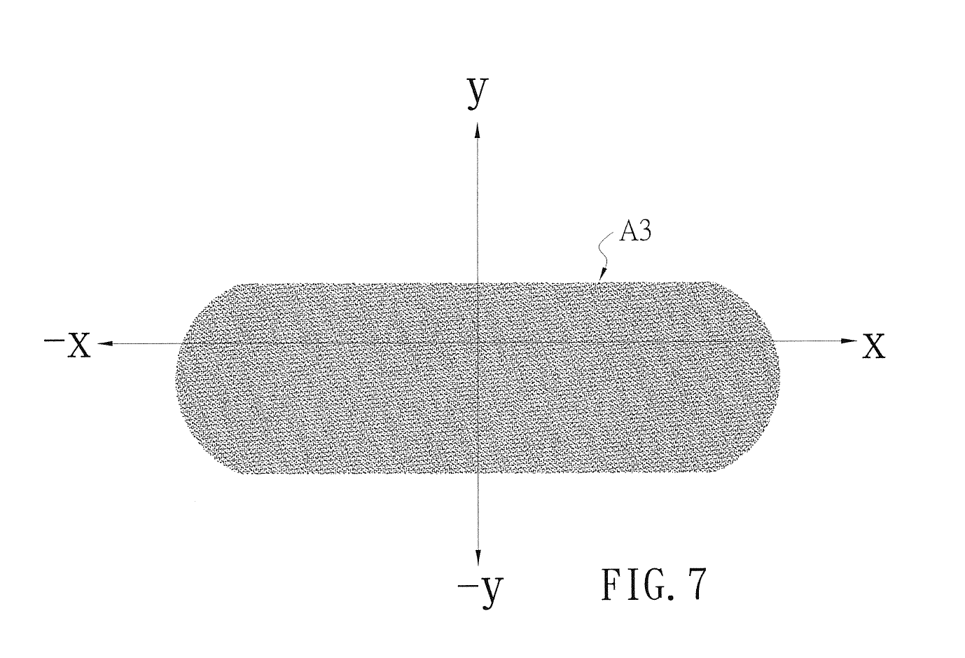

As referring to FIG. 7, it shows a sectional shape A3 of the light beam is formed by the light source passing through the terminal lens (3). The length of the sectional shape (A3) along the X-axis and −X-axis directions shows an symmetrical state, and the width of the sectional shape (A2) along the Y-axis and −Y-axis directions shows an asymmetrical state. Further speaking, when it makes any sections on the terminal lens (3) along the Y-axis and −Y-axis directions and parallel to the X-axis and −X-axis directions, the X-axis curvature of the first and second surface areas (321) (322) is symmetric to that of the fourth and third surface areas (324) (323) of the section, and when it makes any sections on the terminal lens (3) along the X-axis and −X-axis directions and parallel to the Y-axis and −Y-axis directions, the Y-axis curvature of the first and second surface areas (321) (322) is asymmetric to one of the fourth and third surface areas (324) (323) of the section.

In addition, the shape of light projected from the primary lens (2) further conforms to the cross-sectional shape of the light incident surface (31) of the terminal lens (3).

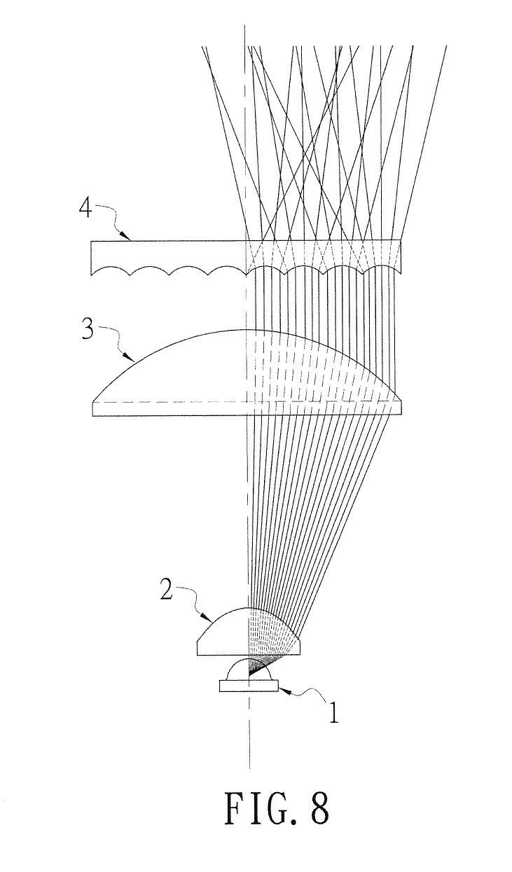

As referring to FIG. 8, it shows that a light-shaped lens (4) is further disposed on the light emergent side of the terminal lens (3) for projecting a necessary light shape by the refraction thereof.

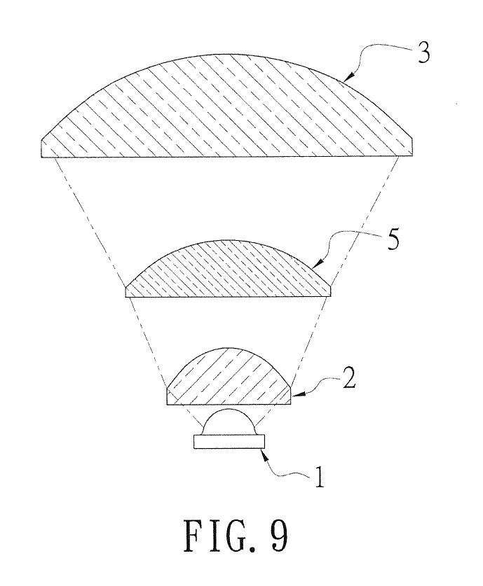

As referring to FIG. 9, at least one intermediate lens (5) is disposed between the primary lens (2) and the terminal lens (3). When only one intermediate lens (5) is disposed between the primary lens (2) and the terminal lens (3), the light emergent angle projected from the primary lens (2) is equal to or smaller than an effective light incident angle of the intermediate lens (5), and the light emergent angle of the intermediate lens (5) is equal to or smaller than an effective light incident angle of the terminal lens (3). When a plurality of the intermediate lens (5) are disposed between the primary lens (2) and the terminal lens (3), the light emergent angle projected from the primary lens (2) is equal to or smaller than the effective light incident angle of the first intermediate lens (5), and the light emergent angle projected from the first intermediate lens (5) is equal to or smaller than the effective light incident angle of the second intermediate lens (5), and so on. The light emergent angle projected from the final intermediate lens (5) is equal to or smaller than the effective light incident angle of the terminal lens (3); in other word, the light emergent angle of a previous-level lens is equal to or smaller than the effective light incident angle of a next-level lens. Accordingly, even if the light projected from the light source (1) passes through the multi-level of the lenses for collecting and projection, it can still be ensure that the light projected from the light source (1) is fully collected and then projected. In addition, the shape of light projected from the primary lens (2) is made to correspondingly conform to the cross-sectional shape of the light incident surface (31) of the intermediate lens (5), and the shape of light projected from the intermediate lens (5) correspondingly conforms to the cross-sectional shape of the light incident surface (31) of the terminal lens (3).

What is claimed is:

1. A lamp structure for improvement of a luminous efficiency, comprising:
a primary lens;
a terminal lens; and
a light source;
wherein the primary lens has an effective light incident angle equal to or larger than a light emergent angle of the light source, so that an light emergent angle from the primary lens is equal to or smaller than an effective light incident angle of the terminal lens.

2. The lamp structure for improvement of a luminous efficiency as claimed in claim 1, wherein the terminal lens comprises a light incident surface and a light emergent surface, and an X-axis ridgeline and a Y-axis ridgeline are intercrossed and formed on the light emergent surface for dividing the light emergent surface into first, second, third and four surface areas; wherein the ridgeline is defined by a line formed by the intersection of two adjacent surface areas on which plural highest points are formed, and the two adjacent surface areas have corresponding overlapped points which the same curvature relative to any arbitrary highest point of the ridgeline; when a first surface region defined by the first and fourth surface areas has a X-axis curvature same with that of a second surface region defined by the second and third surface areas, and a third surface region defined by the first and second surface areas has a Y-axis curvature same with that of a fourth surface region defined by the third and fourth surface areas, the X-axis curvature is not equal to the Y-axis curvature.

3. The lamp structure for improvement of a luminous efficiency as claimed in claim 2, wherein at least one intermediate lens is disposed between the primary lens and the terminal lens, and the light emergent angle of a previous-level intermediate lens is equal to or smaller than the effective light incident angle of a next-level intermediate lens.

4. The lamp structure for improvement of a luminous efficiency as claimed in claim 3, wherein a light-shaped lens is disposed on a light emergent side of the terminal lens.

5. The lamp structure for improvement of a luminous efficiency as claimed in claim 3, wherein the shape of light projected from the primary lens conforms to the cross-sectional shape of the light incident surface of the intermediate lens, and the shape of light projected from the intermediate lens conforms to the cross-sectional shape of the light incident surface of the terminal lens.

6. The lamp structure for improvement of a luminous efficiency as claimed in claim 2, wherein the shape of light projected from the primary lens conforms to the cross-sectional shape of the light incident surface of the terminal lens.

7. The lamp structure for improvement of a luminous efficiency as claimed in claim 1, wherein a light-shaped lens is disposed on a light emergent side of the terminal lens.

8. The lamp structure for improvement of a luminous efficiency as claimed in claim 1, wherein at least one intermediate lens is disposed between the primary lens and the terminal lens, and the light emergent angle of a previous-level intermediate lens is equal to or smaller than the effective light incident angle of a next-level intermediate lens.

9. The lamp structure for improvement of a luminous efficiency as claimed in claim 8, wherein a light-shaped lens is disposed on a light emergent side of the terminal lens.

10. The lamp structure for improvement of a luminous efficiency as claimed in claim 8, wherein the shape of light projected from the primary lens conforms to the cross-sectional shape of the light incident surface of the intermediate lens, and the shape of light projected from the intermediate lens conforms to the cross-sectional shape of the light incident surface of the terminal lens.

11. The lamp structure for improvement of a luminous efficiency as claimed in claim 1, wherein the shape of light projected from the primary lens conforms to the cross-sectional shape of the light incident surface of the terminal lens.
